(19) United States
(12) Patent Application Publication
(10) Pub. No.: US 2024/0184699 A1
(43) Pub. Date: Jun. 6, 2024

(54) AN EFFICIENT AND SCALABLE ARCHITECTURE AND METHOD FOR ISOGENY-BASED CRYPTOSYSTEMS

(71) Applicant: PQSecure Technologies, LLC, Boca Raton, FL (US)

(72) Inventors: Rami El Khatib, Boca Raton, FL (US); Brian C. Koziel, Plano, TX (US)

(73) Assignee: PQSecure Technologies, LLC, Boca Raton, FL (US)

(21) Appl. No.: 17/787,427

(22) PCT Filed: May 25, 2021
(86) PCT No.: PCT/US21/33994

§ 371 Date: Dec. 1, 2022

(51) Int. Cl. G06F 12/0831; G06F 12/0864

(52) U.S. Cl. CPC G06F 12/0831; G06F 12/0864

(57) ABSTRACT

A computer processing isogeny-based cryptosystem method and architecture having at least one cryptosystem controller operably configured to initiate and supervise isogeny-based cryptosystem operations, at least one read-only memory operably configured to read instruction sequences and constants used to perform operations within an isogeny-based cryptosystem, at least one random-access memory operably configured to read and write intermediate data for the isogeny-based cryptosystem, and at least one of an isogeny computational unit operably configured to perform isogeny-based arithmetic. The isogeny computational unit also includes a program control unit operably configured to control the operations within the isogeny-based cryptosystem through a sequence of instructions and an instruction control unit operably configured to control an arithmetic logic unit and random-access memory interactions that include loading and storing data to the least one random-access memory.

### FIELD OF THE INVENTION

The present invention relates generally to hardware, software, and systems directed towards implementing isogeny-based cryptosystems, and, more particularly, describes an efficient hierarchical approach and method for performing computations in isogeny-based cryptography.

### BACKGROUND OF THE INVENTION

Cryptography provides the backbone to a wide variety of security in today's digital applications. More specifically, deploying cryptosystems in digital devices achieves essential information security properties including data confidentiality, data integrity, authentication, and non-repudiation. These digital devices can range from small and low-power microcontrollers that interact with digital sensors to large servers that form the Internet. The implementation of cryptography in these devices through a suite of cryptosystems does not come for free. There is an inherent area, power, timing, and energy consumption associated with any supported cryptosystem.

Furthermore, there are a wide variety of cryptosystems that have been proposed for use in our digital infrastructure. Some of these have been standardized through standardizing organizations such as the National Institute of Standards and Technology (“NIST”). One new security feature of emerging cryptosystems has been their resistance to attacks from quantum computers. Isogeny-based cryptosystems have been seen as one new hope for today's public-key cryptography as they provide quantum-resistant key establishment methods with the smallest known public keys. Further new schemes have continued to be proposed. However, isogeny-based cryptosystem implementation is complex as a system must support a variety of elliptic curve and isogeny arithmetic.

Therefore, a need exists to overcome the problems with the prior art as discussed above.

### SUMMARY OF THE INVENTION

The invention provides a hardware, software, and system architecture that is efficient for both small computing devices as well as large computing devices. This method is hierarchical in that the invention provides the minimum number of components at each computation level and the interaction of these components can be fine-tuned for low or high-performance operation. Furthermore, these additional protections can easily be added into this architecture to provide resistance to various fault attacks.

This hierarchical architecture can be made to support a variety of isogeny-based cryptosystems. For instance, this architecture can support, but is not limited to, any combination of the supersingular isogeny Diffie-Hellman (SIDH) key exchange, the supersingular isogeny key encapsulation (SIKE) mechanism, the commutative supersingular isogeny Diffie-Hellman (CSIDH) key exchange, or short quaternion isogeny signatures (SQISign).

With the foregoing and other objects in view, there is provided, in accordance with the invention, a computer processing isogeny-based cryptosystem architecture that includes at least one cryptosystem controller operably configured to initiate and supervise isogeny-based cryptosystem operations, at least one read-only memory operably configured to read instruction sequences and constants used to perform operations within an isogeny-based cryptosystem, at least one random-access memory operably configured to read and write intermediate data for the isogeny-based cryptosystem, and at least one of an isogeny computational unit operably configured to perform isogeny-based arithmetic. The at least one of an isogeny computational unit has a program control unit operably configured to control the operations within the isogeny-based cryptosystem through a sequence of instructions and an instruction control unit operably configured to control an arithmetic logic unit and random-access memory interactions that include loading and storing data to the least one random-access memory.

In accordance with another feature, an embodiment of the present invention includes a hash computational unit operably configured to generate a hash utilized in the isogeny-based cryptosystem operations.

In accordance with yet another feature, an embodiment of the present invention also includes the random-access memory being of a single port memory unit.

In accordance with yet another feature, an embodiment of the present invention also includes the random-access memory being of a multiple port memory unit.

In accordance with a further feature, an embodiment of the present invention also includes the program control unit having a plurality of counter units operably configured to track the sequence of instructions.

In accordance with an additional feature, an embodiment of the present invention also includes the plurality of counter units in the program control unit having a plurality of duplicate counter units operably configured to detect operation failures within the sequence of instructions.

In accordance with yet another feature, an embodiment of the present invention also includes a data bus controller interfaced between the at least one random-access memory and the isogeny computational unit.

In accordance with an additional feature, an embodiment of the present invention also includes the data bus controller being operably configured to facilitate in the loading of data from the at least one random-access memory to the arithmetic logic unit and the storing of data from the arithmetic logic unit to the at least one random-access memory.

In accordance with an exemplary feature, an embodiment of the present invention also includes a secret key utilized in the isogeny-based cryptosystem and operably configured to be loaded into the program control unit. The secret key is operably configured to be loaded from the at least one random-access memory to the program control unit.

In accordance with yet another feature, an embodiment of the present invention also includes an instruction bus controller interfaced between the least one read-only memory and the isogeny computational unit.

In accordance with a further feature, an embodiment of the present invention also includes the instruction bus controller being operably configured to facilitate in the loading of data from the at least one read-only memory to the program control unit and the storing of data from the program control unit to the at least one read-only memory.

Also in accordance with the present invention, a method of utilizing a computer processing isogeny-based cryptosystem is disclosed that includes initiating isogeny-based cryptosystem operations with at least one cryptosystem controller, reading instruction sequences and constants with at least one read-only memory to perform computations within the isogeny-based cryptosystem operations, reading inputs from at least one random access memory for use in the computations within the isogeny-based cryptosystem operations, writing results from the computations within the isogeny-based cryptosystem operations to the at least one random access memory, performing isogeny-based arithmetic with an isogeny computational unit, controlling the isogeny computational unit with a program control unit receiving instructions from the at least one read-only memory, controlling an arithmetic logic unit with an instruction control unit using the instruction sequences and constants specifying what computations are to be performed, and generating results from the computations within the isogeny-based cryptosystem operations and the inputs from the at least one random access memory.

Further, the method may include supervising the isogeny-based cryptosystem operations with the at least one cryptosystem controller and generating a hash utilized in the isogeny-based cryptosystem operations with a hash computational unit.

Additionally, the method may include reading inputs from a single port memory unit for use in the computations within the isogeny-based cryptosystem operations, reading inputs from a multiple port memory unit for use in the computations within the isogeny-based cryptosystem operations, loading a secret key into the program control unit for use in the computations within the isogeny-based cryptosystem operations, tracking the sequence of instructions with a plurality of counter units in the program control unit, and detecting operational failures within the plurality of counter units, through a plurality of duplicate counter units, within the sequence of instructions.

Although the invention is illustrated and described herein as embodied in a system and method for efficiently implementing isogeny-based cryptosystems, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention.

While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time. Also, for purposes of description herein, the terms “upper”, “lower”, “left,” “rear,” “right,” “front,” “vertical,” “horizontal,” and derivatives thereof relate to the invention as oriented in the figures and is not to be construed as limiting any feature to be a particular orientation, as said orientation may be changed based on the user's perspective of the device. Furthermore, there is no intention to be bound by any expressed or implied theory presented in the preceding technical field, background, brief summary or the following detailed description.

As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. In this document, the term “longitudinal” should be understood to mean in a direction corresponding to an elongated direction of any processing chip. The terms “program,” “software application,” and the like as used herein, are defined as a sequence of instructions designed for execution on a computer system.

A “program,” “computer program,” or “software application” may include a subroutine, a function, a procedure, an object method, an object implementation, an executable application, an applet, a servlet, a source code, an object code, a shared library/dynamic load library and/or other sequence of instructions designed for execution on a computer system.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is a schematic diagram depicting one exemplary hierarchical approach for isogeny-based cryptosystem implementations in accordance with one embodiment of the present invention;

FIG. 2 is a schematic diagram depicting one exemplary hierarchical approach for isogeny-based cryptosystem implementations in accordance with one embodiment of the present invention, specifically showing more details of the ISO UNIT;

FIG. 3 is a schematic diagram depicting one exemplary hierarchical approach for isogeny-based cryptosystem implementations in accordance with one embodiment of the present invention, specifically showing that the key is loaded from the data RAM;

FIG. 4 is a schematic diagram depicting the isogeny unit's interactions in accordance with one embodiment of the present invention;

FIG. 5 is a schematic diagram depicting the isogeny unit's flow interactions in accordance with one embodiment of the present invention; and

FIG. 6 is a process-flow diagram depicting an exemplary method of utilizing a computer processing isogeny-based cryptosystem in accordance with the present invention.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

The present invention provides a hardware, software, and system architecture and method that is efficient for both small computing devices as well as large computing devices. Here, we define efficient as using fewer operations, gates, or area to achieve a similar performance as a naïve approach. Here, we define core components necessary to support isogeny-based cryptosystems by using a simple hierarchy. This hierarchy reduces the size of the resulting implementation by requiring only what is needed.

Isogeny-based cryptography is a type of cryptosystem secured by hard problems of isogenies on elliptic curves. In modern-day cryptography, isogenies on elliptic curve groups is thought to be a hard problem, even for quantum computers. As those of skill in the art will appreciate, an isogeny on elliptic curves φ: E₁→E₂ is a non-rational map of all points on E₁ to E₂ that preserves the point at infinity. Given a finite kernel and E₁, it is simple to compute E₂, the isogeny of E₁ using the finite kernel. However, given only E₁ and E₂, it is a computationally intensive task to compute the finite kernel used for the isogeny from E₁ to E₂, which is the foundation of isogeny-based cryptography. Some examples of isogeny-based cryptography include, but not limited to, supersingular isogeny key encapsulation (“SIKE”) mechanism, the supersingular isogeny Diffie-Hellman (“SIDH”) key exchange protocol, commutative supersingular isogeny Diffie-Hellman (“CSIDH”) key exchange protocol, and SeaSign signatures, CSI-FiSh signatures, SQISign signatures, and supersingular isogeny hash functions. Each of these are isogeny-based cryptosystems that are based on the hardness of isogenies on elliptic curves. The cryptosystem parameters differ in many ways. For instance, these schemes generally use isogenies of elliptic curves, where the elliptic curve is defined over a large finite field. The present invention utilizes a hierarchical architecture that can be made to support a variety of isogeny-based cryptosystems. Supporting a cryptosystem means supporting lower computations such as the scheme's isogenies or a hash function if used.

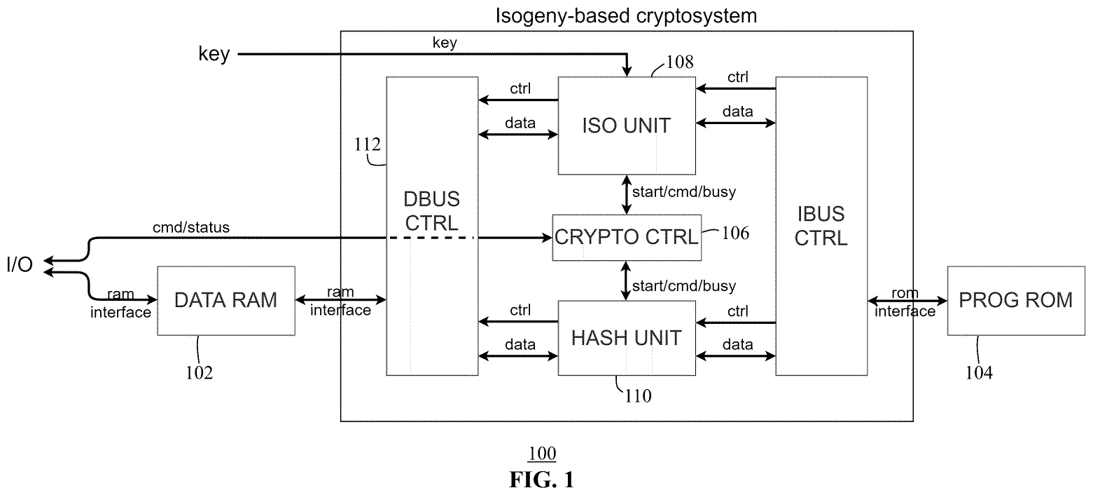

The present invention's core hierarchy is shown in FIG. 1. FIG. 1 also depicts computer processing isogeny-based cryptosystem architecture 100 in accordance with one embodiment of the present invention. The high-level core components of this hierarchy include a data random access memory (RAM) 102 for storing and reading data, a program read-only memory (ROM) 104 for reading program instructions and constant data, cryptosystem controller (CRYPTO CTRL) 106 to issue protocol steps, isogeny unit (ISO UNIT) 108 for computing elliptic curve and isogeny arithmetic, and a hash computational unit (HASH UNIT) 110 for performing hash functions. Each of these components are separated as their operation and function is independent, providing a simple interface and allowing each component to be optimized separately. These components are also similarly labeled in one or more of the other figures.

On the left side of FIG. 1 is the input and output to the device that can issue a command (labeled as “cmd”), read the status of an operation, and/or write/read new data in the DATA RAM 102. The command interface writes and issues a cryptosystem's procedure, initiating an entire sequence necessary to complete the cryptographic protocol through isogeny and hash operations. The DATA RAM 102 provides a link between the data used by the implementation and data coming in from the outside world. Once a cryptosystem procedure is initiated, the isogeny unit 108 computes the elliptic curve and isogeny arithmetic in the protocol and the hash unit performs any hash operations that are used in the protocol. The hash computational unit 110 may also be described as being operably configured to generate a hash utilized in the isogeny-based cryptosystem operations. The DBUS CTRL 112 is a shared interface between the isogeny unit 108 and hash unit 110 so that a single interface is used to access the DATA RAM 102. The data bus controller 112 may also be described as being interfaced between the RAM 102 and the isogeny computational unit 108. The data bus controller 112 may also be operably configured to facilitate in the loading of data from the at least one random-access memory to the arithmetic logic unit and the storing of data from the arithmetic logic unit to the at least one random-access memory.

Said another way, at the left side of FIG. 1 is the input/output (I/O) interface where some outside device will interact with this architecture. The typical use case for a device that wants to call a cryptographic implementation from the present invention is to write some input data to the DATA RAM 102 block through the RAM interface, issue a cryptosystem command through cmd, and then wait for the status signal to indicate that the operation has completed. The cryptosystem command interacts with the top-level cryptosystem controller 106 that controls one or both of the one or more isogeny unit(s) 108 and hash unit(s) 110. Preferably, however, the architecture depicted in the FIG. 1 is the architecture utilized to best effectuate the benefits of the present invention. The cryptosystem controller 106 can initiate and control any step in supported isogeny-based cryptosystem schemes.

As seen in FIG. 1, the one or more cryptosystem controller(s) 106 are operably configured to initiate and supervise isogeny-based cryptosystem operations, the one or more DATA RAMs 104 are operably configured to read instruction sequences and constants used to perform operations within an isogeny-based cryptosystem, the one or more DATA RAMs 102 are operably configured to read and write intermediate data for the isogeny-based cryptosystem, and one or more isogeny computational unit(s) 108 operably configured to perform isogeny-based arithmetic.

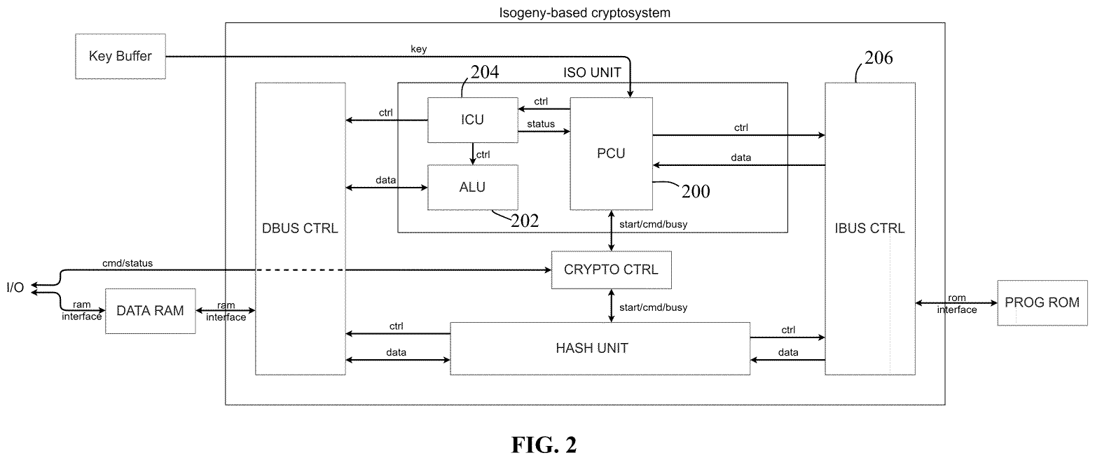

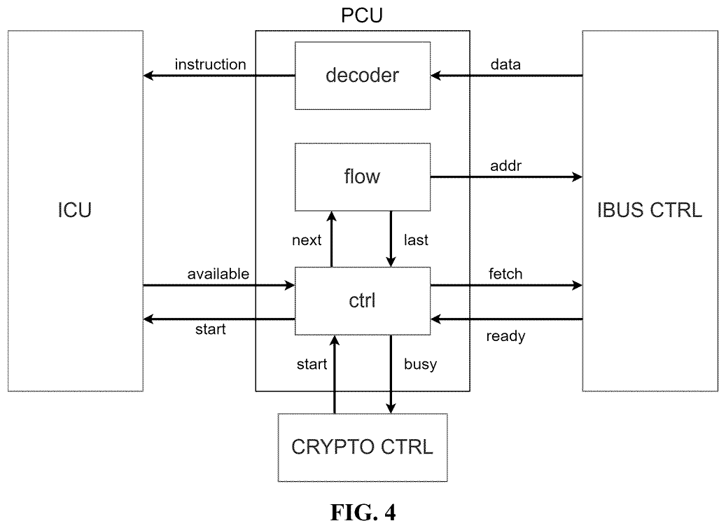

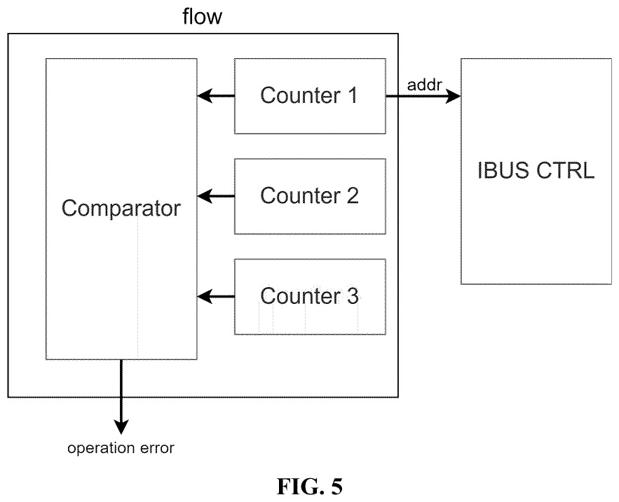

Exemplary, but preferred, internals of the isogeny unit 108 are shown in FIG. 2. Referring both to FIGS. 1-2 and although not required, the same internals could be applied to the hash unit 110. The isogeny unit 108 may include a program control unit (PCU) 200 that is operably configured to handle the sequence of operations used in an isogeny or hash operation, an arithmetic logic unit (ALU) 202 that is operably configured to perform arithmetic operations, and an instruction control unit (ICU) 204 that is operably configured to control the ALU 202 and interacts with the DBUS 112. The PCU 200 is operable to read its instructions and any constants from the program ROM (PROG ROM) 104 through the IBUS CTRL 206, which is a shared interface between the isogeny unit 108 and hash unit 110 so that a single interface is used to access the stored constant data. Said another way, the program control unit 200 is operably configured to control the operations within the isogeny-based cryptosystem through a sequence of instructions and the instruction control unit 204 is operably configured to control the arithmetic logic unit 202 and random-access memory 102 interactions that include loading and storing of data to the random-access memory 102. As best seen with reference to FIGS. 4-5, the PCT 200 may also beneficially include a plurality of counter units operably configured to track the sequence of instructions and the plurality of counter units in the PCU 200 also beneficially include a plurality of duplicate counter units operably configured to detect operation failures within the sequence of instructions.

The isogeny unit 108 and hash unit 110 are configured to both fetch and receive instructions and critical constant data from the PROG ROM 104 through the instruction bus controller (IBUS CTRL) 206. The instruction bus controller 206 may also be beneficially interfaced between the ROM and the isogeny computational unit 108. The instruction bus controller 206 is also beneficially operably configured to facilitate in the loading of data from the ROM 104 to the program control unit 200 and the storing of data from the program control unit 200 to the ROM 104. This hierarchical approach allows an implementation to easily customize which isogeny-based cryptosystems are supported. For instance, to support SIKE, one would include isogeny instructions, constants, and hash functions that are specified by SIKE. Although the figures show the architecture as a read-only memory unit, the architecture is not limited to said particular and effective design choice, and it is still in the spirit of the invention to use any other variety of memory. For instance, a random access memory to read and write these instructions and constant data could be used in place and also give the additional benefit of implementation flexibility. Further, in some embodiments, the RAM 102 and ROM 104 may be swapped with one another; therefore, ROM may be defined herein as any memory you can read data from and RAM may be defined herein as any memory you can read and write from.

The selection of the DATA RAM type also allows for a variety of performance profiles. For instance, a small implementation could use a single port DATA RAM can be used that allows a single read or write operation per device cycle. A large and high-performance implementation could use a three port DATA RAM block that allows up to three read or writes operation per device cycle. This increased number of ports reduces the latency of reading and storing arithmetic values at the cost of additional interface overhead. It is a simple task to swap out the DATA RAM block for any multiple port memory module. These ports can also simply be dedicated to a read or write operation. For instance, consider a two-port memory module that has a single read port and a single write port. It is within the spirit of this invention that any type of memory unit is used as the DATA RAM. Said another way, the RAM 102 may be beneficially of a single port memory unit or a multiple port memory unit.

The flexibility in separate computational components also allow for multiple schemes to be supported. Utilizing SIKE and CSIDH as two examples, SIKE performs a chain of 2- or 3-isogenies while CSIDH performs a sequence of 2-, 3-, 5-, . . . isogenies. Despite these having different isogeny computations, each necessary isogeny subroutine can be included in the PROG ROM 104 and both flows can be implemented and supported by the isogeny PCU unit 200.

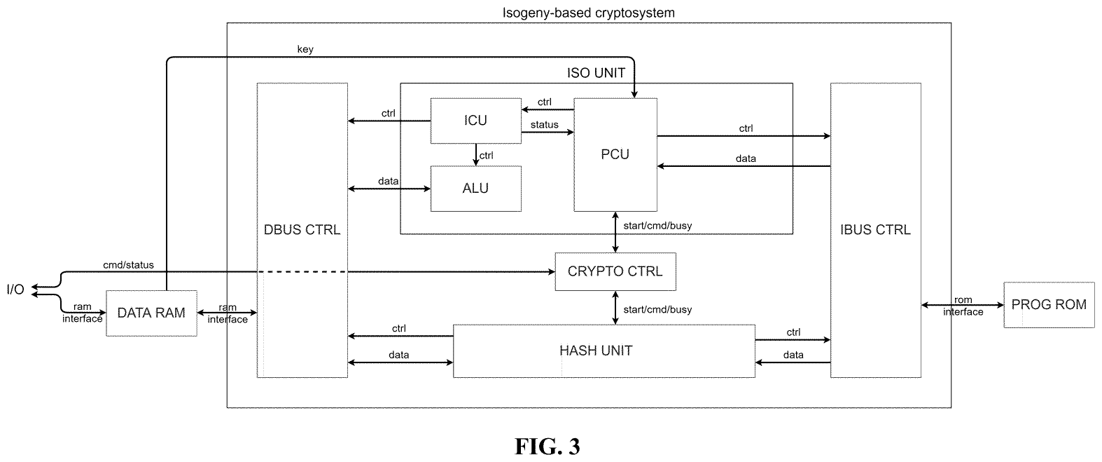

For public-key cryptography, a private key is a key that is meant to be kept secret for use in key establishment or digital signature schemes, for instance. As such, this private key can come from a variety of sources. For instance, some secure implementations might use a special protected region of memory to store the private key. With specific reference to FIG. 2, the secret key is depicted as being stored in a Key Buffer that is located somewhere outside the isogeny-based cryptosystem. This private key is used in the isogeny unit 108 according to the isogeny-based cryptosystem. The secret key is utilized in the isogeny-based cryptosystem and operably configured to be loaded into the program control unit 200 and operably configured to be loaded from the RAM 102 to the program control unit 200. In FIG. 3, we show that the DATA RAM is another option to load and store the private key. We note that this is still not the only option for storage of the private key. For instance, the private key could be stored in read-only memory 104, also within or outside the isogeny-based cryptosystem.

With reference to FIG. 4, a schematic diagram depicting the isogeny unit's 108 exemplary but preferred interactions is depicted. For example, after the PCU 200 receives a “start” signal from the cryptosystem controller 106, a sequence of operations will begin and the PCU 200 will output “busy” until the operation is complete. First, the PCU 200 will initialize the program's address in the “flow” block, issue a fetch to the IBUS CTRL 206, and issue a start to the ICU 204. Based on the flow block's address (addr), the instruction bus (IBUS) 206 will return the appropriate instruction as the “data” line that goes into the PCU decoder. Here, the decoder interprets the instruction data to return the correct instruction to the ICU 204. The ICU 204 will then issue the controls and data bus sequence necessary to perform the instruction. Upon completing the instruction, the ICU 204 will return an “available” signal to the PCU control and the PCU control will increment the flow address and continue operation. Once the flow reaches the last instruction in the isogeny operation, the flow will output the “last” status bit indicating that the flow is on its last instruction. When this last instruction is then complete and the ICU 204 returns the “available” signal, the PCU 200 has finished and will now invert the “busy” signal to the cryptosystem controller 106, indicating to the cryptosystem controller 106 that the operation has completed. This same operation flow can also be applied to the hash unit 110 or another computational unit.

The isogeny unit 108 is a computational unit that performs various arithmetic operations. Here, a computation includes one or more inputs, a choice of arithmetic to perform, and the results of the computation. As an example, consider an isogeny unit that can perform addition, subtraction, and multiplication. A modular addition operation takes two inputs a, b to compute c=a+b. The inputs are generally read from either the DATA RAM for general data or from the PROG ROM for constants. The decoded instruction in the isogeny unit's ICU dictate where the inputs are loaded from, which arithmetic operation (of addition, subtraction, or multiplication) to perform, as well as where to store the result. Typically, the result will be stored at some address in the DATA RAM. There are a wide variety of arithmetic computations to perform, such as modular arithmetic, elliptic curve arithmetic, or isogeny arithmetic. Each of these have inputs, outputs, and the type of operation.

As a further example, we describe an efficient implementation of the PCU 200 for the isogeny unit 108 in the case of supporting SIKE. The SIKE key generation procedure computes a long chain of 3-isogenies, such as 3e. The most efficient process to compute this large-degree isogeny involves performing a specific strategy of elliptic curve point multiplications by 3 and isogenous point mappings of degree 3. The optimal strategy here resembles traversing a directed tree where the root node is a point of order 3e and each leaf node is a point of order 3. Since a point of order 3 is required for a 3-isogeny computation, this tree must be traversed by multiplying a point by 3 and evaluating a 3-isogeny, which both reduce the order by a factor of 3. An optimal strategy is one of least cost, which typically involves storing multiple pivot points. To implement this, a PCU can include 5 counters to perform this strategy. The first counter is called the main iterator, which tracks how many consecutive point tripling operations or isogeny evaluations are left in the step of the strategy. The second counter is called the isogeny counter, which tracks how many isogenies have been computed so far. The index iterator tracks the current index in the tree. The point iterator tracks how many pivot points have not yet been pushed through the isogeny computations. Lastly, the strategy address is the fifth counter, which tracks the current step of the strategy for the large-degree isogeny operation.

With reference to FIG. 5, an example of the “flow” block in a PCU is illustrated. Because of the dependence of these many counters, one possible weakness is if a counter fails, whether by flawed computation or a malicious attack. Here, the simple defense is to simply add duplicate, i.e., redundant, counters. If the redundant counters do not match, then an alert can be sent to the top-level controller to notify of a failed operation. In FIG. 5, assume that each “Counter” is keeping track of the same internal value for the PCU 200. Let us assume it is which instruction to read from the PROG ROM 104. A comparator is used to compare the results of each of these counters. If one counter does not match, then some kind of implementation error has occurred, which could be accidental or malicious. If the Counters are not equal, then an “operation error” signal is sent to the PCU 200 which is sent to the cryptosystem controller 106 to determine an appropriate course of action. For simplicity, we show that the counter value stored in Counter 1 goes to the IBUS CTRL 206, but this could easily be swapped to a majority function or other simple selection function among each Counter. If any counters are incorrect, then an implementation should be check if the isogeny operation finished correctly.

As a further example, we describe an efficient implementation of the ICU 108 for the isogeny unit in the case of supporting SIKE. The instruction controller must interact with the ALU 202 to perform each instruction. At the lowest level, isogeny-based cryptosystems are based on finite-field arithmetic. SIKE uses low-level prime field arithmetic as well as quadratic extension field arithmetic. Thus, the ICU 204 receives an instruction for a prime field operation, such as a modular multiplication, or a quadratic extension field operation, such as a quadratic extension addition, and issues the correct loads and stores to the DATA RAM 102 through the DBUS CTRL 112 and correct arithmetic control to perform the operation.

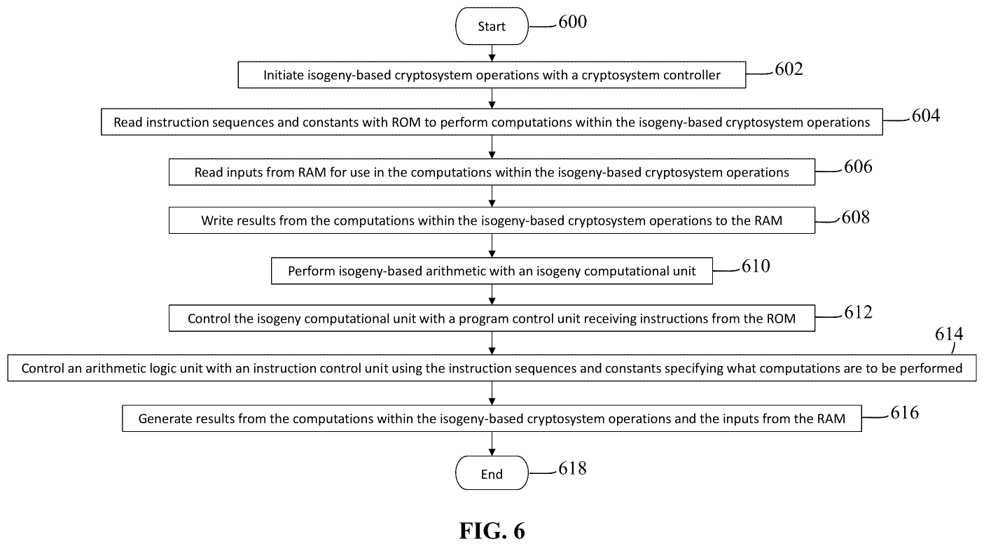

The above description and FIGS. 1-5 will now be described in conjunction with the process flow chart of FIG. 6. Although FIG. 6 shows a specific order of executing the process steps, the order of executing the steps may be changed relative to the order shown in certain embodiments. Also, two or more blocks shown in succession may be executed concurrently or with partial concurrence in some embodiments. Certain steps may also be omitted in FIG. 6 for the sake of brevity. In some embodiments, some or all of the process steps included in FIG. 6 can be combined into a single process. The process of utilizing a computer processing isogeny-based cryptosystem depicted in FIG. 6 begins with step 600 and immediately proceeds to step 602 of initiating isogeny-based cryptosystem operations with at least one cryptosystem controller utilizing, for example, the above-described architecture. Additionally, the process may include supervising the isogeny-based cryptosystem operations with the at least one cryptosystem controller. The process may also include generating a hash utilized in the isogeny-based cryptosystem operations with a hash computational unit.

Next, step 604 includes reading instruction sequences and constants with at least one read-only memory to perform computations within the isogeny-based cryptosystem operations and step 606 includes reading inputs from at least one random access memory for use in the computations within the isogeny-based cryptosystem operations. In one embodiment, the process may include reading inputs from a single port memory unit or multiple port memory unit for use in the computations within the isogeny-based cryptosystem operations. Thereafter, step 608 includes writing results from the computations within the isogeny-based cryptosystem operations to the at least one random access memory.

Thereafter, step 610 includes performing isogeny-based arithmetic with an isogeny computational unit and step 612 includes controlling the isogeny computational unit with a program control unit receiving instructions from the at least one read-only memory. In one embodiment, the process may include loading a secret key into the program control unit for use in the computations within the isogeny-based cryptosystem operations. Step 614 includes controlling an arithmetic logic unit with an instruction control unit using the instruction sequences and constants specifying what computations are to be performed and step 616 includes generating results from the computations within the isogeny-based cryptosystem operations and the inputs from the at least one random access memory. In one embodiment, the process may include tracking the sequence of instructions with a plurality of counter units in the program control and detecting operational failures within the plurality of counter units, through a plurality of duplicate counter units, within the sequence of instructions. The process may terminate in step 618.

What is claimed is:

1. A computer processing isogeny-based cryptosystem architecture comprising:
at least one cryptosystem controller operably configured to initiate and supervise isogeny-based cryptosystem operations;
at least one read-only memory operably configured to read instruction sequences and constants used to perform operations within an isogeny-based cryptosystem;
at least one random-access memory operably configured to read and write intermediate data for the isogeny-based cryptosystem; and
at least one of an isogeny computational unit operably configured to perform isogeny-based arithmetic and having:
a program control unit operably configured to control the operations within the isogeny-based cryptosystem through a sequence of instructions; and
an instruction control unit operably configured to control an arithmetic logic unit and random-access memory interactions that include loading and storing data to the least one random-access memory.

2. The computer processing isogeny-based cryptosystem architecture according to claim 1, further comprising:
a hash computational unit operably configured to generate a hash utilized in the isogeny-based cryptosystem operations.

3. The computer processing isogeny-based cryptosystem architecture according to claim 1, wherein the random-access memory is a single port memory unit.

4. The computer processing isogeny-based cryptosystem architecture according to claim 1, wherein the random-access memory is a multiple port memory unit.

5. The computer processing isogeny-based cryptosystem architecture according to claim 1, wherein the program control unit further comprises:
a plurality of counter units operably configured to track the sequence of instructions.

6. The computer processing isogeny-based cryptosystem architecture according to claim 5, wherein the plurality of counter units in the program control unit further comprises:
a plurality of duplicate counter units operably configured to detect operation failures within the sequence of instructions.

7. The computer processing isogeny-based cryptosystem architecture according to claim 1, further comprising:
a data bus controller interfaced between the at least one random-access memory and the isogeny computational unit.

8. The computer processing isogeny-based cryptosystem architecture according to claim 7, wherein the data bus controller is operably configured to facilitate in the loading of data from the at least one random-access memory to the arithmetic logic unit and the storing of data from the arithmetic logic unit to the at least one random-access memory.

9. The computer processing isogeny-based cryptosystem architecture according to claim 1, further comprising:
a secret key utilized in the isogeny-based cryptosystem and operably configured to be loaded into the program control unit.

10. The computer processing isogeny-based cryptosystem architecture according to claim 9, wherein the secret key is operably configured to be loaded from the at least one random-access memory to the program control unit.

11. The computer processing isogeny-based cryptosystem architecture according to claim 1, further comprising:
an instruction bus controller interfaced between the least one read-only memory and the isogeny computational unit.

12. The computer processing isogeny-based cryptosystem architecture according to claim 11, wherein the instruction bus controller is operably configured to facilitate in the loading of data from the at least one read-only memory to the program control unit and the storing of data from the program control unit to the at least one read-only memory.

13. A method of utilizing a computer processing isogeny-based cryptosystem comprising:
initiating isogeny-based cryptosystem operations with at least one cryptosystem controller;
reading instruction sequences and constants with at least one read-only memory to perform computations within the isogeny-based cryptosystem operations;
reading inputs from at least one random access memory for use in the computations within the isogeny-based cryptosystem operations;
writing results from the computations within the isogeny-based cryptosystem operations to the at least one random access memory;
performing isogeny-based arithmetic with an isogeny computational unit;
controlling the isogeny computational unit with a program control unit receiving instructions from the at least one read-only memory;
controlling an arithmetic logic unit with an instruction control unit using the instruction sequences and constants specifying what computations are to be performed; and
generating results from the computations within the isogeny-based cryptosystem operations and the inputs from the at least one random access memory.

14. The method according to claim 13, further comprising:
supervising the isogeny-based cryptosystem operations with the at least one cryptosystem controller.

15. The method according to claim 13, further comprising
generating a hash utilized in the isogeny-based cryptosystem operations with a hash computational unit.

16. The method according to claim 13, further comprising:
reading inputs from a single port memory unit for use in the computations within the isogeny-based cryptosystem operations.

17. The method according to claim 13, further comprising:
reading inputs from a multiple port memory unit for use in the computations within the isogeny-based cryptosystem operations.

18. The method according to claim 13, further comprising:
loading a secret key into the program control unit for use in the computations within the isogeny-based cryptosystem operations.

19. The method according to claim 13, further comprising:
tracking the sequence of instructions with a plurality of counter units in the program control unit.

20. The method according to claim 19, further comprising:
detecting operational failures within the plurality of counter units, through a plurality of duplicate counter units, within the sequence of instructions.
